(19) United States
(12) Patent Application Publication
(10) Pub. No.: US 2025/0340388 A1
(43) Pub. Date: Nov. 6, 2025

(54) PRODUCT HANDLING DEVICE AND PRODUCTION MACHINE

(71) Applicant: Syntegon Technology GmbH, Waiblingen (DE)

(72) Inventors: Johannes Baeuerle, Obersontheim (DE); Sebastian Gran, Crailsheim (DE); Matthias Schwandt, Wallhausen (DE); Sebastian Schwarz, Würzburg (DE)

(21) Appl. No.: 18/867,515

(22) PCT Filed: May 25, 2023
(86) PCT No.: PCT/EP2023/064137

§ 371 Date: Nov. 20, 2024

(30) Foreign Application Priority Data
May 25, 2022 (DE) 10 2022 113 318.4
Dec. 20, 2022 (DE) 10 2022 134 165.8

(51) Int. Cl. B65G 54/02; B65G 43/00; B65G 47/00

(52) U.S. Cl. CPC B65G 54/02; B65G 43/00; B65G 47/00

(57) ABSTRACT

A product handling device (12) for the handling, in particular for the conveying, of products (14), has at least two movers (16, 16′) and has a coupling unit (18) which mechanically couples the movers (16, 16′) with one another. A support unit (24) for at least one product (14) is provided and includes at least two connection units (26, 26′), which respectively connect the support unit (24) with at least one of the movers (16, 16′). The connection units (26, 26′) and the support unit (24) are connected to one another in each case within a plane (28) in which the support unit (24) is arranged. The connection units (26, 26′) each comprise at least one orientation unit (32, 32′), the orientation units being coupled with one another, and the orientation units (32, 32′) each comprise at least one bevel gear (36, 36′).

### CROSS-REFERENCE TO RELATED APPLICATIONS

This patent application is a U.S. national stage application of international patent application PCT/EP2023/064137, filed on May 25, 2023, which is based on and claims priority to German patent application DE 10 2022 113 318.4, filed on May 25, 2022, and to German patent application DE 10 2022 134 165.8, filed on Dec. 20, 2022, the contents of which are incorporated herein by reference.

### BACKGROUND

The invention concerns a product handling device and a production machine.

From the prior art, for example from the document US 2020/0030995 A1, a product handling device with a mechanical coupling of movers is already known. The movers are connected to one another by parallelogram kinematics. The disadvantage is here that the kinematics has at least one dead center, and a support unit for receiving/supporting products, which is connected and/or coupled with the movers, may tip, actually tip over, during movement of the movers, such that there may be a lack of stability, namely with regard to a stable positioning and/or holding of the support unit with respect to the movers. Furthermore, mechanical couplings of movers via spur gears and legs are known, which however have the disadvantage that those couplings require a lot of room and space and in the prior art have up to now been arranged in a region below the support unit, which makes access to the products on/in the support unit from two sides considerably more difficult.

Furthermore, from DE 199 20 776 A1, US 2019/270203 Al and KR 2021-0000006 A, product handling devices for a handling of products, comprising at least two movers and a coupling unit which mechanically couples the movers with one another and which includes a support unit for at least one product and at least two connection units, which respectively connect the support unit with at least one of the movers, are already known.

Moreover, from US 2018/096622 A1 a movement simulator is already known, with a handling device for a handling, in particular for a movement in a space, of a vehicle motion simulator cabin.

### SUMMARY

The objective of the invention is in particular to provide a generic product handling device and/or a generic production machine with improved properties regarding stability and/or flexibility when handling products. The objective is achieved according to the invention.

The invention is based on a product handling device for a handling, in particular for a conveying, of products, with at least two movers and with a coupling unit which mechanically couples the movers with one another and which comprises a support unit for at least one product and at least two connection units, which respectively connect the support unit with at least one of the movers, wherein the connection units and the support unit are connected to one another in each case within a plane in which the support unit is arranged, and wherein the connection units each comprise an orientation unit, said orientation units being coupled with one another.

It is proposed that the orientation units each comprise at least one bevel gear.

Improved stability and/or high flexibility when handling products may be provided by such an implementation. It is furthermore possible to provide a particularly stable construction and/or arrangement of a support unit with at least two movers. Moreover, even during movement of the movers, the support unit may preferably be held and/or arranged and/or supported at least substantially parallel to an orientation of the movers, such that tipping, specifically tipping over, of the support unit can be avoided and/or prevented. By means of the proposed mechanical coupling, it is possible to dispense with parallelogram kinematics and thus in turn to avoid and/or bypass at least one dead center. This in turn allows augmenting safety and/avoiding and/or preventing damage to products. In addition, comfort and flexibility in the handling of products, specifically at least during a conveying and/or transferring and/or transporting and/or processing and/or sorting of products, can be increased. Arrangement and connection of the support unit with at least two connection units within a plane in which the support unit is arranged allows providing and/or facilitating access to the support unit from two sides, specifically above all access to products from an underside of the support unit for improved handling of the products. Thus it is just possible to improve flexibility and comfort regarding a machining and/or a processing and/or a further treatment of products which are arranged on/in the support unit. Furthermore, it is thus possible to increase efficiency, specifically with regard to cost efficiency and/or product efficiency and/or operation efficiency and/or work efficiency.

The product handling device is configured for a handling of products, specifically for example for a conveying, moving, transporting and/or transferring of products. Preferably the product handling device is a subassembly group of a product handling system. However, it would also be conceivable that the product handling device constitutes the entire product handling system. The product handling system is, without being limited thereto, configured for the handling, in particular for the conveying and/or transporting and/or sorting, of products and may comprise further devices and/or units which are deemed expedient by someone skilled in the art and which are usable and expedient for the handling of products. The product handling system may also be part of a production machine. However, it would possibly also be conceivable that the product handling system constitutes the entire production machine. The production machine is, without being limited thereto, configured for a production and/or manufacture of products, and in particular for the handling of products. The production machine may also be configured, for example, for the machining and/or processing, metering, mixing, preparation, filling, packaging, closing, conveying and/or transporting of bulk materials, for example of food products, and may comprise further devices, systems and/or units which are deemed expedient by someone skilled in the art and which are usable and expedient for the production and/or manufacture, in particular for the handling, of products.

Possibly the product is non-packaged, in particular a non-packaged food product, such as for example an apple, a pear or the like. Particularly preferentially the product is an at least partially packaged product, the product comprising at least one packaging and a bulk material arranged in the packaging. The bulk material may be, for example, a solid, liquid, pasty and/or chunky bulk material. The product may also be, for example, a food product, a pharmaceutical product, consumer goods, a beauty and/or body care product, such as for example chips, sauces, dairy products, in particular yoghurts, bread spreads, pastes, ready-to-eat meals, confectionery, creams and/or shampoos or the like. It would also be conceivable that the product is realized as consumer goods and/or as an object from the field of toys, handicraft, kitchen and/or household or the like, such as for example a toy car, a scoop, a pot, a small electrical appliance, for example a mixer and/or kitchen scales, and/or a screw. The product may be any conceivable product that is deemed expedient by someone skilled in the art.

Products can be moved, transported, sorted and/or transferred by means of at least two movers. In particular, the movers are realized as electrodynamically movable movers. The product handling system advantageously comprises a base unit. The base unit may form a base and/or a plane with the movers, in particular the at least two movers and preferably all movers of the plurality of movers, being supported movably relative to the base and/or plane. Preferably the product handling system comprises at least one drive unit, in particular an electrodynamic drive unit, by means of which the movers are movable. In particular when viewed in a height direction, the drive unit may be arranged at least partially below the base unit. In particular, the movers are movable relative to the base unit, specifically drivable by means of the drive unit. Preferably, in at least one operation state, specifically in at least one activated state, the drive unit generates electromagnetic forces, in particular an electromagnetic alternating field, for driving the movers. Preferably, a drive force acting on the movers can be generated by means of the drive unit, in particular in order to generate and/or induce a movement, preferably a translational movement and/or a rotational movement, of the movers relative to the base unit. The movers may be displaceable and/or rotatable relative to the base unit in at least two degrees of freedom. However, it would also be conceivable that the movers can be tilted relative to the base unit and/or can be moved relative to the base unit in at least a third degree of freedom. Preferably, the movers are movable at least substantially parallel to the base unit, namely in a movement plane extending parallel to the base unit. Preferentially, the drive unit is configured to drive the movers for movements which run at least substantially parallel to the base unit. Herein “substantially parallel” is to mean an orientation of a direction relative to a reference direction, in particular in a plane, with the direction differing from the reference direction by less than 8°, advantageously less than 5° and particularly advantageously less than 2°.

The base unit may comprise at least one plate-shaped/plate-like element or may be realized as such. An object being realized in “plate-shaped/plate-like” fashion is to mean a spatial object which, when viewed in a developed view in a plane, and viewed in a cross-section perpendicular to the plane, has a non-circular cross-sectional area and an in particular at least substantially constant material thickness, which amounts to less than 50%, preferably less than 25% and particularly preferably less than 10% of an area extent of the spatial object parallel to the plane, in particular a smallest area extent of the object parallel to the plane. Furthermore, it is to mean that at least one smallest possible geometric cuboid, which just still completely encloses the object, is plate-shaped. Preferably the movers are movable at least substantially parallel to the plate-shaped element. In particular, the movers are realized in plate-shaped/plate-like fashion.

Advantageously the movers each comprise at least one magnetic field generating element for generating a magnetic field. The magnetic field generating element is realized for example as a magnet, in particular as a permanent magnet, or the like. In particular, the magnetic field generating element is configured to interact with the drive unit for driving the mover. For example, an interaction of the magnetic field generating element with the drive unit generates an air gap between the base unit and the mover. The mover may float above the base unit at a distance of for example at least 1 mm, advantageously at least 3 mm and preferably at least 5 mm when viewed in a height direction. Alternatively, however, it is also conceivable that the drive unit is realized as a fluid-based planar drive. Preferably the descriptions of the mover, in particular regarding a drive by the drive unit, analogously apply to all movers which are part of the product handling device, wherein the product handling device may comprise, for example, at least four, six, ten or more movers.

It would also be conceivable that several movers, specifically additional movers to the two movers, are mechanically coupled with one another, specifically by means of the coupling unit. Advantageously the support unit comprises at least one plate-shaped/plate-like element or is realized as such an element. However, it would also be conceivable that the support unit comprises a bag and/or funnel and/or the like or is realized as a bag or funnel or the like. In particular, depending on what kind of product is to be handled, the support unit may be realized correspondingly such that it is capable of receiving and/or holding and/or storing and/or carrying the product. Depending on a size and/or a shape and/or an implementation of the support unit, more than said two movers may be mechanically coupled with one another. The support unit may, for example, have a round, oval or angular shape. Preferentially the support unit has an at least substantially tetragonal shape, for example a square or rectangular shape. The support unit is in particular configured to receive and/or carry and/or hold and/or store at least the product, preferentially a plurality of products. The support unit may comprise at least one receiving element, which receives at least the product. The receiving element may serve as and/or be realized as an insert at least for the product or the plurality of products and/or as a frame for holding at least the product or the plurality of products. Preferably the support unit has at least one through-opening so as to preferentially provide access from two sides at least to the product that is arranged on/in the support unit. The receiving element may have at least the opening. Preferentially several products are arrangeable on the support unit, for example in rows. Via the mechanical coupling to the movers, at least the product arranged on the support unit, in particular the plurality of products, can be handled, specifically at least moved, transported and/or transferred. It would also be conceivable that the receiving unit comprises at least one gripper for a gripping of products. The receiving element could be realized as the gripper, as an adapter for a—preferably detachable—connection to a gripper, or the like, or as a different receiving element for products that is deemed expedient by someone skilled in the art.

Preferentially at least the product is arrangeable and/or arranged on the support unit for further treatment and/or further processing and/or further handling. For example, at least the product arranged on/in the support unit can be further packaged and/or closed, weighed, removed out of/from the support unit and/or re-inserted into/onto the support unit. The production machine may comprise at least one product processing unit, which is configured for a processing and/or handling at least of the product that is arranged on/in the support unit. The product processing unit may further process and/or handle at least the product on an upper side and/or on an underside of the support unit. The product processing unit may, for example, remove at least the product out of/from the support unit and/or re-insert it onto/into the support unit and/or arrange it on/in the support unit. Furthermore, the product processing unit may, for example, be realized as scales or may comprise scales, in particular in order to weigh at least the product, specifically preferably on the underside of the support unit.

In particular, the support unit is realized mirror-symmetrically along at least one symmetry plane. Advantageously, the symmetry plane is at least substantially perpendicular to the support unit, in particular to the plane in which the support unit is arranged. In this context, “at least substantially perpendicular” is to mean at an angle between 85° and 95°, preferably between 88° and 92° and especially advantageously of 90°, wherein advantageously an angle between an object and/or a plane, in particular of the support unit, and a further object and/or a further plane, in particular the symmetry plane, differs from a right angle by at most 5°, preferably by at most 2° and particularly advantageously by at most 1°.

Preferably the support unit is arranged, and advantageously movable, at least substantially parallel to the movers, in particular to the base unit. In particular, the support unit is movable, preferably translationally movable, relative to the movers, advantageously to the base unit. Preferentially, due to the coupling with the movers via the connection units, the support unit can be arranged and/or positioned at different distances and/or in different positions relative to the movers, in particular to the base unit. Via the connection units, respectively one of the movers is mechanically movably connected to the support unit. If the product handling device in particular comprises further movers, which are additional to the two movers and are connected to the support unit via the coupling unit, the coupling unit may comprise further connection units, which are additional to the two connection units. Preferably the coupling unit comprises at least as many connection units as there are movers which are mechanically coupled with one another via the support unit. The connection units could in each case comprise at least one connection element, which is connected to at least one of the movers and/or is fixed on at least one of the movers. It is possible that the first connection unit comprises at least one first connection element and the second connection unit comprises a second connection element. The connection element, in particular the first and/or the second connection element, may be realized, for example, as a strut or the like. The connection element, in particular the first and/or the second connection element, could also be referred to as a stabilization element for a stabilization of the support unit with respect to at least one of the movers. Advantageously, the connection element is movably connected with the mover. Alternatively, however, it is also conceivable that the connection element is rigidly connected at least with the mover.

For better explanation, on the basis of the at least two movers, this document refers to a first mover and to at least one second mover. The first mover and the second mover are respectively connected to the support unit via at least one of the connection units. In particular, the first mover is connected to the support unit via a first connection unit of the connection units. Advantageously, the second mover is connected to the support unit via a second connection unit of the connection units. In particular, the first connection unit and the second connection unit are connected to the support unit in each case within the plane in which the support unit is arranged.

The coupling unit could be realized at least partly integrally, advantageously in a one-part implementation, with at least one of the two movers. Furthermore, at least one of the connection units or the two connection units could be realized at least partly integrally, advantageously in a one-part implementation, with the support unit and/or with at least one of the movers. In particular, the connection elements are realized at least partly integrally, advantageously in a one-part implementation. Furthermore, the support unit may be realized at least partly integrally or in a one-part implementation. “Integrally” is to mean connected at least by material bond, for example by an adhesive-bonding process, an injection-molding process and/or a welding process and/or another process that is deemed expedient by someone skilled in the art. “In a one-part implementation” is to mean formed in one piece. Preferably this one piece is produced from a single blank, a mass and/or a cast, for example in an injection-molding procedure, in particular a single-component and/or multi-component injection-molding procedure, and/or in a punching procedure and/or in a sheet-metal bending process and/or in a printing process, for example a 3D printing process, and/or is produced from the single blank in another process/method that is deemed expedient by someone skilled in the art.

The support unit, the connection unit and/or the movers may be made at least partly, advantageously at least to a large extent or completely, of a mineral, a plastic, a metal and/or a composite material. In the present case, the term “to a large extent” is to mean for example at least 55%, advantageously at least 65%, preferably at least 75%, particularly preferably at least 85% and particularly advantageously at most 95% of a total volume and/or total mass.

Advantageously said plane is spanned at least by the support unit. In particular, a main extension plane of the support unit is situated in said plane. Particularly preferentially the plane intersects with the support unit and at least partly with the at least two connection units, in particular the first connection unit and at least the second connection unit. In the present case, a “main extension plane” of an object is to mean a plane which is oriented parallel to a largest side surface of a smallest imaginary cuboid just still completely enclosing the object, and in particular extends through the center point of the cuboid. In particular, said plane extends at least substantially parallel to the base unit, specifically to a main extension plane of the base unit, when the support unit is arranged with respect to the base unit, in particular when the movers are arranged on the base unit. Furthermore, the plane may be oriented at least substantially parallel to the at least two movers, specifically to a main extension plane of the movers.

In the present document, numerals, such as for example “first” and “second”, which precede certain terms merely serve to distinguish objects and/or to allocate objects to one another, but they do not imply an existing total number and/or ranking of the objects. In particular, a “second object” does not necessarily imply a presence of a “first object”. Particularly preferably, unless stated or described otherwise, descriptions and/or explanations relating to a “first object” can be transferred analogously to an at least “second object”. Furthermore, here and in the following “configured” is to mean specifically programmed, designed and/or equipped. By an object being configured for a certain function is to be understood that the object fulfils and/or carries out this certain function in at least one application state and/or operation state.

In addition, it would possibly be conceivable that at least one of the connection units or at least both connection units, in particular the first connection unit and/or the second connection unit, is/are connected to the support unit at least partly above and/or below the plane. For example, at least one of the connection units could additionally be connected to the support unit at least substantially perpendicular to the plane, wherein an angle between the plane and the connection unit differs from a right angle by at most 5°, preferably by at most 2° and particularly advantageously by at most 1°.

It is further proposed that the connection units are connected to the support unit in an outer peripheral region of the support unit. This allows augmenting flexibility and comfort even further, since accessibility to products arranged on/in a support unit can be improved. It is moreover possible to provide access to the support unit from two sides for machining and/or further processing and/or handling of products.

The support unit may comprise a frame element which at least section-wise, preferably completely, defines and/or forms or comprises the outer peripheral region of the support unit. Preferentially the connection units, in particular the first connection unit and the second connection unit, are connected with the frame element. At least the receiving element, for receiving at least the product, may be arranged in an inner region of the frame element. The frame element may at least section-wise, preferably completely, enclose and/or surround the receiving element. In particular, the frame element delimits the receiving element at least section-wise towards the outside, preferably within said plane. The frame element and at least the connection element may be realized at least partly integrally, advantageously in a one-part implementation. The frame element and at least the receiving element may jointly define and/or form the plate-like/plate-shaped element of the support unit. The frame element may have an angular, round or oval shape, or the like. Particularly preferentially, the frame element is realized at least substantially square-like or rectangularly.

According to the invention, the connection units each comprise at least one orientation unit, said orientation units being coupled with one another. This allows improving stability as well as a construction and/or arrangement of a mechanical coupling of at least two movers. Moreover, a symmetrical movement of at least two connection units, which are in each case connected to one of the movers, can be generated and/or provided and/or enabled.

Each of the at least two connection units comprises at least one of the orientation units. In addition, the connection units may also comprise several orientation units, for example two, three or five. Preferentially the connection units, in particular the first connection unit and the second connection unit, always have the same number of orientation units, wherein in each case at least one of the orientation units of one connection unit is coupled with at least one other orientation unit of the other connection unit. The first connection unit may comprise a first orientation unit. The second connection unit may comprise a second orientation unit. In particular, the first orientation unit and the second orientation unit are, in particular mechanically, coupled with one another. Due to the mechanical coupling of the orientation units with one another, a symmetrical movement guidance of the at least two connection units can be generated and/or provided and/or enabled.

Beyond this, it is proposed that the orientation units are connected to one another within the plane in which the support unit is arranged. As a result, a construction can be further optimized with regard to stability, flexibility and comfort. It is also possible to further improve accessibility to products that are arranged on/in a support unit.

In particular, the first orientation unit and the second orientation unit are connected to one another within the plane in which the support unit is arranged. Further orientation units of the connection units can in each case be coupled with one another within said plane. Preferentially, always at least two orientation units, specifically in each case at least one of the orientation units of one connection unit and at least one other orientation unit of the other connection unit are connected within said plane. Advantageously the orientation units, in particular the first orientation unit and at least the second orientation unit, are connected with the frame element.

In particular, in each case at least one of the connection elements and at least one of the orientation units are connected to one another, preferably specifically within said plane. The first connection element may be connected with the first orientation unit, specifically within said plane. The second connection element may be connected with the second orientation unit, specifically within said plane. Preferentially, the connection elements are configured to create and/or provide a connection between the movers and at least the orientation units.

It is in particular possible to generate a rotational movement of the connection elements relative to the movers and/or to the support unit by means of the orientation units. The orientation units may be configured to adjust an angle orientation between the support unit and at least the connection elements. Due to the coupling of the orientation units with one another, in particular of the first orientation unit and of at least the second orientation unit, the movements of the connection elements, in particular of the first connection element and of at least the second connection element, are coupled and/or connected with one another and/or depend on one another. If at least one of the movers—and thus also at least one of the connection elements—moves, this will induce a movement of the respective other connection element and/or of the mover due to the coupling of the connection elements via the orientation units. For example, if the first mover carries out a movement and thus moves the first connection element, the first orientation unit can likewise move and, due to the coupling with at least the second orientation unit, can initiate and/or induce a movement of the at least second orientation unit and thus also at least of the second connection element.

In order to provide particularly high stability of a construction and to improve safety, regarding at least one product arrangement with respect to a support unit, and thus in turn to avoid and/or prevent damage to products, it is proposed that the orientation units are configured to always align the support unit parallel to the movers. Moreover, the support unit can thus be held and/or arranged and/or supported at least substantially parallel to an orientation of the movers, even during movement of movers, such that tipping, specifically tipping over, of the support unit can be avoided and/or prevented.

Preferably, an angle orientation between the support unit and at least the connection elements can be adjusted in a step-less manner by a movement of at least the orientation units. In particular, the orientation units are configured to always align, preferentially to hold the main extension plane of the support unit at least substantially parallel to the main extension plane of the movers, specifically advantageously at least during a movement of at least one of the connection elements, in particular of the first connection element and/or of at least the second connection element, and/or of the movers.

According to the invention, the orientation units each comprise at least one bevel gear. This allows further optimizing a construction, augmenting stability and particularly simply and precisely adjusting an angle orientation between connection units and a support unit. In particular, the bevel gear is configured to have a deflection of a torque, respectively of a rotational speed, in particular transmitted via the connection elements, of at least substantially (advantageously exactly) 90 degrees. Alternatively, differing angles may also be possible.

If the orientation units each comprise at least one bevel wheel, it is possible to provide a particularly efficient, compact and/or simple construction as well as a particularly efficient, compact and/or simple mechanical coupling of movers. Preferentially the orientation units each comprise further bevel wheels, specifically at least two bevel wheels. In particular, the bevel gears are in each case realized as a bevel wheel pair or comprise at least one bevel wheel pair.

In order to provide a particularly efficient, compact and/or flexible construction and to further increase stability and flexibility when handling products, it is proposed that the bevel wheels are respectively arranged in a corner region of the support unit. In particular the bevel wheels are arranged in a corner region of the frame element. For example, if the frame element has an at least substantially tetragonal or rectangular shape, the bevel wheels may be respectively arranged in a corner region of the tetragon or of the rectangle. Preferably, always at least two bevel wheels, specifically at least one bevel gear, are/is arranged in the corner region of the support unit. At least one orientation unit of the orientation units may be arranged per each corner region of the support unit. The first orientation unit, in particular a first bevel gear with advantageously at least two bevel wheels, may be arranged in a first corner region of the support unit, in particular of the frame element. The second orientation unit, in particular a second bevel gear with advantageously at least two bevel wheels, may be arranged in a second corner region of the support unit, in particular of the frame element. If the support unit, in particular the frame element, has an at least substantially tetragonal or rectangular shape, the first corner region and the second corner region may be arranged opposite each other, advantageously when viewed in a main extension direction of the support unit. Advantageously the support unit, in particular the frame element, has in addition to the first corner region and the second corner region further corner regions, preferably an even number of corner regions. Alternatively, an uneven number of corner regions would also be conceivable. A “main extension direction” of an object is in the present case to mean a direction that runs parallel to a longest edge of a smallest geometric cuboid just still completely enclosing the object. In particular, the main extension direction of the object runs within a main extension plane of the object.

In order to further improve stability as well as a construction and/or arrangement of a mechanical coupling of at least two movers, it is proposed that the bevel gears are connected to one another by means of a shaft. This moreover allows providing a simple and/or efficient coupling of at least two orientation units, specifically bevel gears. Moreover, a symmetrical movement of at least two connection units, which are respectively connected to one of the movers, can be generated and/or provided and/or enabled.

In particular, the shaft is part of the product handling device. The coupling unit, advantageously at least one of the connection units, in particular the first connection unit and/or the second connection unit, may comprise at least the shaft. Advantageously the coupling unit comprises at least one further shaft or several additional shafts, wherein preferably the number of shafts is related to a number of orientation units. The coupling unit may in each case comprise one shaft per at least two orientation units. Particularly preferentially each of the connection units comprises at least one shaft. In particular, the orientation units, namely the at least two orientation units, are connected to one another by the shaft. The first orientation unit may be connected with the second orientation unit by the shaft. In particular, the shaft is configured to connect the first orientation unit with at least the second orientation unit. Preferably the shaft extends from the first corner region to the second corner region. Further orientation units of the connection units, in particular of the first connection unit and of at least the second connection unit, may likewise be connected to one another via a shaft, in particular the shaft.

In particular, the shaft connects the first orientation unit in the first corner region with at least the second orientation unit in the second corner region. The frame element is capable of accommodating at least the shaft. Advantageously the shaft is arranged within the frame element. In particular, the shaft is arranged completely within the frame element, preferably completely surrounded and/or enclosed and/or covered by the frame element. Alternatively the shaft may be arranged at least partially outside on the frame element, for example fixed and/or held on the frame element, for example by a force-fit and/or form-fit connection. Depending on a size and/or a shape and/or an implementation of the support unit, the shaft may have a size and/or length adapted to the support unit.

For an actuation of at least one mover of the movers, in particular of at least one movement of at least the mover of the movers, it is proposed that the product handling device comprises a control unit which is configured, for a transport of the product, in at least one first operation state, to position at least one of the movers below the support unit in a perpendicular view onto the plane. This allows providing a particularly efficient and/or flexible mechanical coupling of movers since, depending on requirements, with regard to at least one transport situation, specifically a transport and/or a conveying and/or transferring of products, a position and/or an orientation of the movers with respect to a support unit can be adapted. This in turn allows achieving high flexibility and improved comfort when handling products.

In particular, the control unit is configured to actuate the drive unit for moving the movers, in particular the first mover and/or at least the second mover, with respect to the base unit. The control unit is furthermore configured for a controlling and/or regulation at least of a movement of the movers. By a “control unit” is an electronic unit to be understood which is preferably at least partly integrated in a control and/or regulation unit of the product handling system and which is configured to control and/or regulate at least a movement of the movers. Advantageously the control unit comprises a computing unit, in particular a processor, and preferably comprises, in addition to the computing unit, a memory unit with a controlling and/or regulation program that is stored therein and is configured to be executed by the computing unit. The memory unit may be realized as a digital storage medium, for example as a hard disk or the like.

The control unit may, in at least the first operation state, actuate at least one of the movers, in particular the first or the second mover, in such a way that the mover is arranged and/or positioned below the support unit in a perpendicular view onto the plane. At least the mover may, in a perpendicular view onto the plane, be arranged below the support unit by at least 60%, advantageously by at least 80% and preferably by at least 90%. Preferentially, in at least the first operation state, in a perpendicular view onto the plane, at least the mover, in particular the first mover or at least the second mover, is positioned and/or arranged completely below the support unit.

Advantageously the first operation state may be referred to as a transport operation state for a transport at least of the product. Preferentially, in at least the first operation state, the at least two movers move jointly with respect to the base unit, in particular parallel to said plane in which the support unit is arranged.

Preferentially the control unit is configured, in the first operation state, to position the two movers beside one another below the support unit in a perpendicular view onto the plane. This allows providing a particularly efficient, compact and/or space-saving construction. With regard to a transport situation, specifically a transport and/or a conveying and/or transferring of products, this in turn allows optimizing handling of products as well as augmenting flexibility and comfort.

In at least the first operation state, the control unit may actuate at least the two movers, in particular the first and the second mover, in such a way that the two movers are arranged and/or positioned below the support unit in a perpendicular view onto the plane. Viewed perpendicularly onto the plane, the movers could be arranged below the support unit with equal percentages. Viewed perpendicularly onto the plane, the first mover and the second mover may in each case be arranged and/or positioned below the support unit by at least 10%, advantageously by at least 30% and preferably by at least 50%. It would also be conceivable that the first mover is arranged and/or positioned—in a perpendicular view onto the plane—below the support unit by at least 20%, advantageously by at least 30% and preferably by at least 40%. Accordingly, viewed perpendicularly onto the plane, the second mover may be arranged and/or positioned below the support unit for example by at least 60%, advantageously by at least 70%, preferably by at least 80%. At least in the first operation state, the at least two movers could be arranged side by side in a contact-flush manner. Alternatively, viewed perpendicularly onto the plane, the movers could be arranged spaced apart from each other below the support unit. For example, at least in the first operation state, a distance between the at least two movers could be at least 0.5 mm, in particular at least 5 mm, advantageously at least 10 mm, and preferably at most 10 cm, in particular at most 5 cm and particularly preferably at most 2 cm. Preferentially, at least in the first operation state, the at least two movers are arranged completely below the support unit in a perpendicular view onto the plane.

Beyond this it is proposed that the control unit is configured, in at least one second operation state, for a further treatment of the product, to position at least one of the movers at least partially beside the support unit in a perpendicular view onto the plane. This allows providing a particularly efficient and/or flexible mechanical coupling of movers since, depending on requirements, with regard to at least one processing and/or further treatment situation, specifically a machining and/or a processing and/or a further treatment of products, it is possible to adapt a position and/or an orientation of the movers with respect to a support unit. It is moreover possible to provide and/or facilitate access from two sides, specifically above all access to products from an underside of the support unit. This in turn allows achieving high flexibility and improved comfort when handling products.

The control unit may, at least in the second operation state, actuate at least one mover of the at least two movers, in particular the first mover or the second mover, in such a way that the mover is arranged and/or positioned at least partially outside and/or beside the support unit in a perpendicular view onto the plane. At least the mover and the support unit could, at least in the second operation state, be arranged in at least partially overlapping fashion in a perpendicular view onto the plane. The mover, in particular the first mover or the second mover, may, in a perpendicular view onto the plane, be arranged beside the support unit by at least 60%, advantageously by at least 80% and preferably by at least 90%. Preferentially, at least in the second operation state, in a perpendicular view onto the plane, at least the mover, in particular the first mover or the second mover, is positioned and/or arranged completely beside the support unit.

Advantageously the second operation state may be referred to as a further-treatment operation state for a further treatment at least of the product. Preferentially, in at least the second operation state, the at least two movers move jointly with respect to the base unit, in particular parallel to said plane in which the support unit is arranged.

It is further proposed that the control unit is configured, in the second operation state, to position the two movers at least partially beside the support unit in a perpendicular view onto the plane. This allows providing and/or enabling particularly comfortable and/or efficient accessibility of products that are arranged on/in a support unit. Above all, it is possible to facilitate and improve access to products from an underside of the support unit. Moreover, a particularly efficient and/or flexible mechanical coupling of movers can be provided since, depending on requirements, with regard to at least one processing and/or further treatment situation, specifically a machining and/or a processing and/or a further treatment of products, a position and/or an orientation of the movers with respect to the support unit can be adapted.

In at least the second operation state, the control unit may actuate at least the two movers, in particular the first mover and the second mover, in such a way that the two movers are arranged and/or positioned at least partially beside the support unit in a perpendicular view onto the plane. In a perpendicular view onto the plane, the movers, in particular the first mover and the second mover, could be arranged at least partially beside the support unit with equal percentages. For example, in a perpendicular view onto the plane, the first mover and the second mover may be arranged and/or positioned beside the support unit in each case by at least 5%, advantageously by at least 10%, preferably by at least 20%, and in particular by at most 80%, preferably by at most 50% and particularly preferably by at most 30%. It would also be conceivable that the first mover is arranged and/or positioned beside the support unit for example by at least 20%, advantageously by at least 30% and preferably by at least 40% in a perpendicular view onto the plane. Accordingly, in a perpendicular view onto the plane, the second mover may be arranged and/or positioned beside the support unit for example by at least 60%, advantageously by at least 70%, preferably by at least 80%. Preferentially, at least in the second operation state the movers, in particular the first mover and the second mover, are arranged completely beside the support unit in a perpendicular view onto the plane.

In order to further increase efficiency when handling products, it is proposed that at least one of the two movers, in particular the first mover and/or the second mover, is supported so as to be rotatable around a rotation axis relative to the coupling unit. This moreover allows providing more flexible handling of products, specifically at least during a conveying and/or transferring and/or transporting and/or processing and/or sorting of products. Furthermore, it is possible to increase efficiency with regard to cost efficiency, process efficiency, work efficiency, material efficiency and/or product efficiency. It is moreover possible to dispense with a rotation of a product handling device by means of an external mechanism and/or via a laborious and/or complicated and/or unnecessary travel path/transport path.

In particular, this is a general relative movement between the coupling unit and at least one of the movers, in particular the first mover and/or the second mover. At least one of the two movers may be movable, in particular rotatable and/or pivotable, around the rotation axis relative to the coupling unit, wherein the coupling unit or at least a component/structural element of the coupling unit could form a fix and/or stable reference base with respect to which at least the mover is movable. Alternatively and/or additionally, the coupling unit may be supported so as to be rotatable and/or tiltable and/or pivotable relative to at least one of the movers, wherein at least one of the movers could form the fix and/or stable reference base.

The first mover may comprise a first rotary bearing with a first rotation axis around which the first mover is supported rotatably relative to the coupling unit. Furthermore, the second mover may comprise a second rotary bearing with a second rotation axis around which the second mover is supported rotatably relative to the coupling unit. The first mover and/or the second mover may in each case rotate around the respective rotation axis by at least 90°, advantageously by at least 180°, preferably by at least 270° and particularly preferably by at least 360°. The first mover and the second mover could in each case rotate around the respective rotation axis by an at least substantially identical angle. In the present case, “at least substantially” is to mean that a deviation from a given value and/or orientation amounts to less than 10%, preferably less than 5% and particularly preferably less than 2% of the given value and/or orientation.

It would also be conceivable that at least one of the two movers, in particular the first mover and/or the second mover, is configured to perform a tilting and/or pivoting movement around the respective rotation axis. Preferably the rotating, tilting and/or pivoting movement of the at least one mover, in particular the first mover and/or the second mover, takes place with respect to the base unit. In particular, the control unit is configured to actuate at least one of the two movers in such a way that it performs the rotating, tilting and/or pivoting movement around the respective rotation axis relative to the coupling unit. Advantageously, the control unit is configured to actuate the drive unit for moving at least one of the movers, in particular the first mover and/or at least the second mover, with respect to the base unit, specifically for rotating, tilting and/or pivoting. Preferentially the first rotation axis and/or the second rotation axis extends perpendicularly to the base unit.

The product handling device according to the invention and/or the production machine according to the invention shall not be limited here to the application and implementation described above. In particular, in order to fulfil a functionality that is described here, the product handling device and/or the production machine may have a number of individual elements and components that differs from a number given here. Moreover, for the value ranges given in this disclosure, values lying within the mentioned limits shall also be considered as disclosed and as usable as desired.

### BRIEF DESCRIPTION OF THE DRAWINGS

Further advantages will become apparent from the following description of the drawings. An exemplary embodiment of the invention is illustrated in the drawings. The drawings, the description and the claims contain numerous features in combination. Someone skilled in the art will purposefully also consider the features individually and will find further expedient combinations.

In the drawings:

FIG. 1 shows a schematic representation of a production machine with a product handling device,

FIG. 2 shows the product handling device with at least two movers and with a coupling unit for a mechanical coupling of the movers in a first operation state,

FIG. 3 shows a side view of the product handling device according to FIG. 2,

FIG. 4 shows a top view of the product handling device according to FIG. 2,

FIG. 5 shows the product handling device with the at least two movers and the coupling unit for a mechanical coupling of the movers in a second operation state,

FIG. 6 shows a side view of the product handling device according to FIG. 5,

FIG. 7 shows a top view of the product handling device according to FIG. 5, and

FIG. 8 shows the product handling device with the at least two movers and the coupling unit in the second operation state, wherein at least one of the movers is rotated around a rotation axis relative to the coupling unit.

### DETAILED DESCRIPTION

For the sake of clarity, unless stated otherwise, in the following only one of multiple objects present in the figures is provided with a reference numeral. The explanations and descriptions relating to an object can be transferred to the further identical objects. Furthermore, the present figures are schematic representations and are not true to scale.

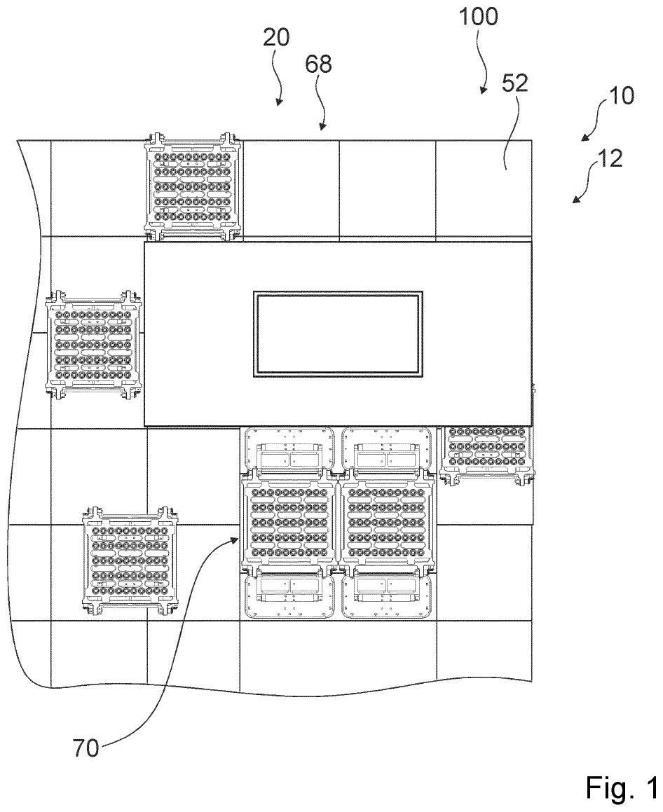

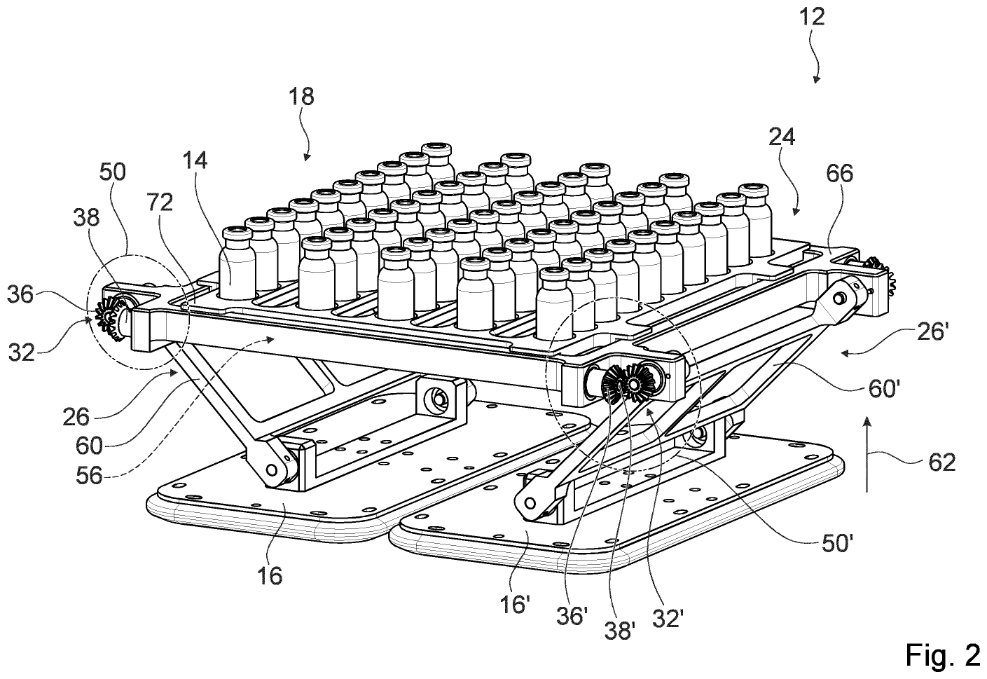

FIG. 1 shows a production machine 10. In the present case, the production machine 10 is configured at least for the manufacture and/or production of products 14. The production machine 10 may also, without being limited thereto, be configured for the machining and/or processing, metering, mixing, preparation, filling, packaging, closing, conveying and/or transporting of bulk materials, for example of food products, and may comprise devices, systems and/or units which are deemed expedient by someone skilled in the art and are usable and expedient for the production and/or manufacture, specifically at least for the handling, of products 14. In this exemplary implementation, the product 14 is an at least partially packaged product 14, the product 14 comprising at least one packaging and the bulk material arranged in the packaging. The bulk material (not shown) is, for example, solid, liquid, pasty and/or chunky. Alternatively, the product 14 could also be a non-packaged product 14. The product 14 may be a food product, a pharmaceutical product, a consumer goods item, a beauty and/or body care product or the like. By way of example, in this implementation filled areas are shown as products 14 (see FIG. 2). The product 14 may also be any other conceivable product 14 deemed expedient by someone skilled in the art.

In the present case, the production machine 10 comprises a product handling system 100. The product handling system 100 is configured for the handling, specifically for the conveying and/or sorting, of products 14. The product handling system 100 comprises at least one product handling device 12. The product handling device 12 is configured for a handling of products 14, specifically for a conveying, moving, transporting, sorting and/or transferring of products. Furthermore, the product handling device 12 comprises at least two movers 16, 16′. In the present case, the movers 16, 16′ are realized as electrodynamically movable movers 16, 16′.

The product handling system 100 comprises a base unit 52 relative to which the movers 16, 16′ are movable. In the present case, the base unit 52 is realized in plate-shaped/plate-like fashion. For driving the movers 16, 16′, the product handling system 100 comprises a drive unit 68. A drive force acting on the movers 16, 16′, specifically an electromagnetic drive force, can be generated by means of the drive unit 68 in order to generate and/or induce a movement, preferably a translational movement and/or a rotational movement, of the movers 16, 16′ relative to the base unit 52. The movers 16, 16′ are movable at least substantially parallel to the base unit 52, specifically in a movement plane extending parallel to the base unit 52. In the present case, the drive unit 68 is configured to drive the movers 16, 16′ for movements that are oriented at least substantially parallel to the base unit 52.

For an actuation of the movers 16, 16′, the product handling device 12 comprises a control unit 20. The control unit 20 is configured for an actuation of the drive unit 68 in order to thereby control and/or regulate at least a movement of the movers 16, 16′. The control unit 20 is at least configured for a controlling and/or regulation of the movement of the movers 16, 16′ in such a way that the movers 16, 16′ convey and/or transport products 14. In the present case, the at least two movers 16, 16′ are movable jointly with respect to the base unit 52 in at least one operation state. Before further details of a movement and/or arrangement of the movers 16, 16′ are discussed, the present construction and the mechanical coupling of the movers 16, 16′ shall first be described in the following.

For a mechanical coupling of the at least two movers 16, 16′, the product handling device 12 comprises a coupling unit 18. It would also be conceivable that several movers 16 of the product handling device 12, specifically additional movers 16 to said two movers 16, 16′, are mechanically coupled with one another, specifically via the coupling unit 18. The coupling unit 18 comprises a support unit 24 for at least the product 14 and comprises at least two connection units 26, 26′, which respectively connect the support unit 24 with at least one of the movers 16, 16′.

The support unit 24 comprises at least one plate-shaped/plate-like element, respectively is in the present case realized as such an element. The support unit 24 could, for example, have a round, oval or angular shape. In this exemplary implementation, the support unit 24 has an angular shape, specifically an at least substantially rectangular, almost square shape. The support unit 24 is configured to receive and/or carry and/or hold at least the product 14, furthermore a plurality of products 14. The support unit 24 may comprise at least one receiving element 72, which receives at least the product 14. The receiving element 72 may serve as an insert at least for the product 14 or the plurality of products 14 and/or as a frame for holding at least the product 14 or the plurality of products 14. In the present case, the support unit 24 has at least one through-opening so as to provide access from two sides at least to the product 14 arranged on/in the support unit 24. The receiving element 72 has in this case the at least one opening. According to FIGS. 2 to 7, it can be seen that in the present case several products 14 are arranged on the support unit 24 in rows. At least the product 14 arranged on the support unit 24, furthermore the plurality of products 14, can be handled, specifically at least moved, transported and/or transferred, via the mechanical coupling with the movers 16, 16′.

The support unit 24 is arranged at least substantially parallel to the movers 16, 16′. The support unit 24 is supported movably relative to the movers 16, 16′, and also to the base unit 52. Due to the coupling with the movers 16, 16′ via the connection units 26, 26′, the support unit 24 is arrangeable and/or positionable at different distances and/or in different positions relative to the movers 16, 16′. Respectively one of the movers 16, 16′ is connected to the support unit 24 via the connection units 26, 26′ in such a way that it is mechanically movable. For better explanation of the present exemplary embodiment, in the following a first mover 16 and a second mover 16′ as well as a first connection unit 26 and a second connection unit 26′ will be referred to. The first connection unit 26 is configured to connect and/or couple the first mover 16 with the support unit 24. The second connection unit 26′ is configured to connect and/or couple the second mover 16′ with the support unit 24.

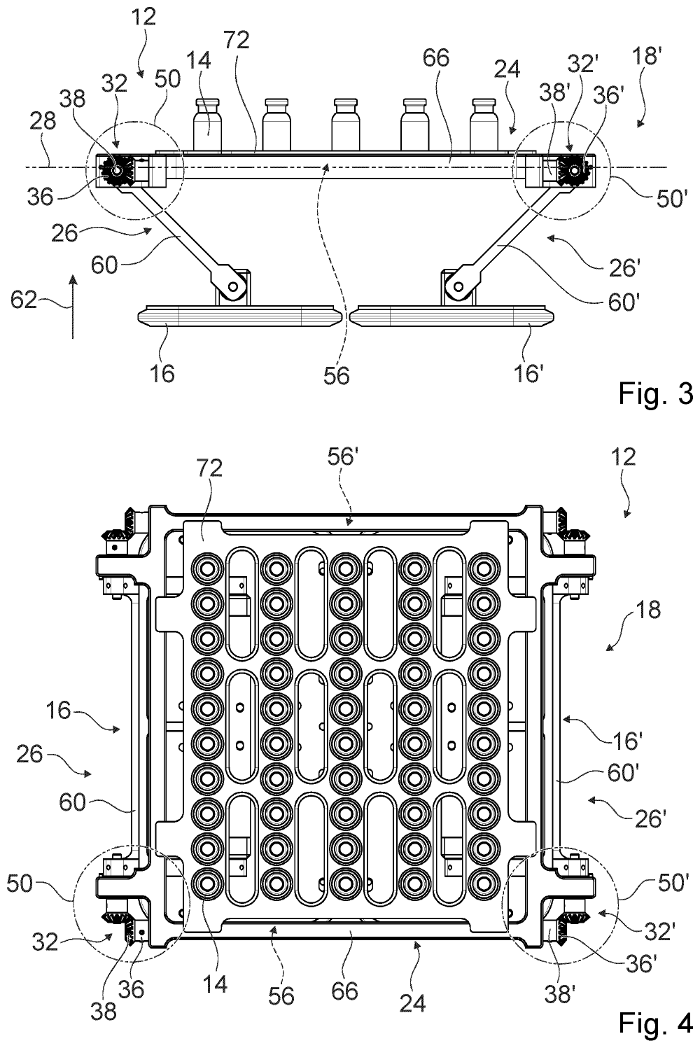

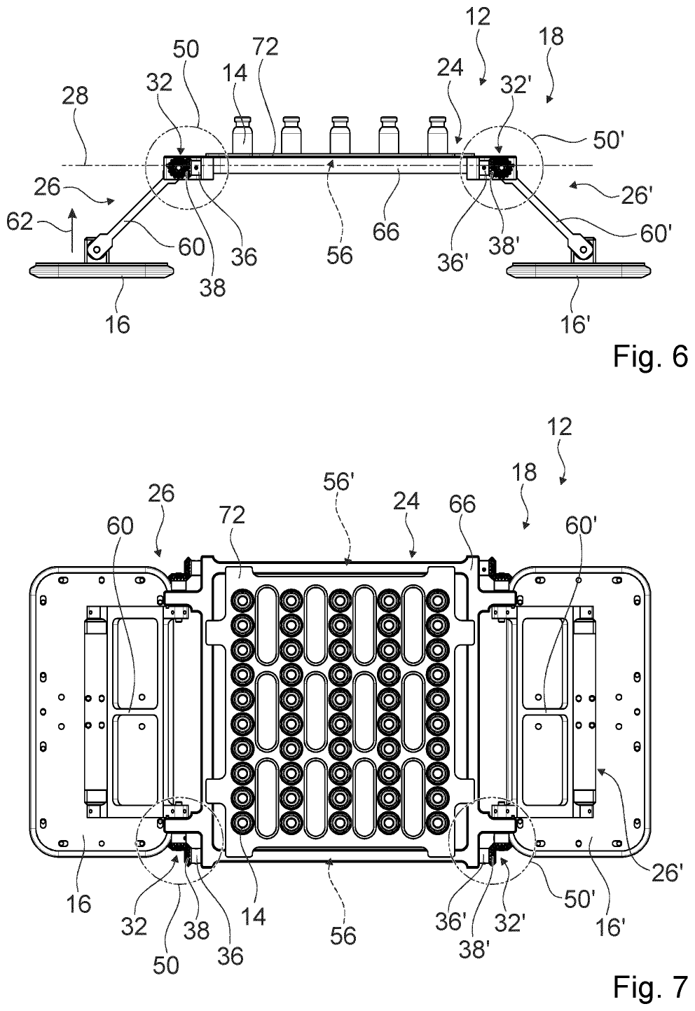

The connection units 26, 26′ and the support unit 24 are connected to one another in each case within a plane 28 in which the support unit 24 is arranged. The plane 28 is schematically indicated by way of example in FIGS. 3 and 6. According to FIGS. 3 and 6, it can be seen that said plane 28 is spanned by a main extension plane of the support unit 24, respectively that the main extension plane of the support unit 24 is situated in the plane 28. The plane 28 intersects with the support unit 24 and at least partly with the at least two connection units 26, 26′. Said plane 28 is arranged at least substantially parallel to the base unit 52, specifically to a main extension plane of the base unit 52, if the movers 16, 16′ are arranged on the base unit 52. Furthermore, the plane 28 is oriented at least substantially parallel to the at least two movers 16, 16′, specifically to a main extension plane of the movers 16, 16′ (see at least FIGS. 3 and 6).

The connection units 26, 26′ each comprise at least one connection element 60, 60′, which is connected to at least one of the movers 16, 16′ and/or is fixed on at least one of the movers 16, 16′. The first connection unit 26 comprises at least one first connection element 60 and the second connection unit 26′ comprises a second connection element 60′. The first connection element 60 is connected to the first mover 16 and, in said plane 28, to the support unit 24. The second connection element 60′ is connected to the second mover 16′ and, in said plane 28, to the support unit 24.

FIGS. 2 to 7 illustrate that the connection units 26, 26′ are connected to the support unit 24 in an outer peripheral region of the support unit 24. In the present case, the support unit 24 comprises a frame element 66. The frame element 66 defines and/or forms the outer peripheral region of the support unit 24. The connection units 26, 26′, specifically the first connection unit 26 and the second connection unit 26′, are connected to the frame element 66. At least the receiving element 72, for receiving at least the product 14, is arranged in an inner region of the frame element 66. In the present case, the frame element 66 surrounds and/or encloses and/or delimits the receiving element 72 at least section-wise towards the outside, specifically-in this exemplary implementation-at least within the plane 28. In the present case, the support unit 24 is realized mirror-symmetrically along at least one symmetry plane. The support unit 24 is mirrored perpendicularly to a symmetry axis that extends through the plane 28. Furthermore, the symmetry plane is perpendicular to the plane 28.

The connection units 26, 26′ each comprise at least one orientation unit 32, 32′, wherein said orientation units 32, 32′ are in turn coupled with one another. Preferentially the connection units 26, 26′, specifically the first connection unit 26 and the second connection unit 26′, always have a same number of orientation units 32, 32′. In this exemplary implementation, each of the connection units 26, 26′ comprises at least two orientation units 32, 32′, such that there are a total of at least four orientation units 32, 32′. For the sake of simplicity, only one orientation unit 32, 32′ per connection unit 26, 26′ will be described in the following, wherein the explanations and descriptions can be transferred to all further orientation units. Furthermore, the first connection unit 26 comprises a first orientation unit 32 of the orientation units 32, 32′ and the second connection unit 26′ comprises a second orientation unit 32′ of the orientation units 32, 32′. The first orientation unit 32 and the second orientation unit 32′ are mechanically coupled with one another.

At least FIGS. 3 and 6 show that the orientation units 32, 32′ are connected to one another within the plane 28 in which the support unit 24 is arranged. The orientation units 32, 32′ are also connected with the frame element 66. In each case at least one of the connection elements 60, 60′ and at least one of the orientation units 32, 32′ are connected to one another, specifically within said plane 28. The first connection element 60 is connected with the first orientation unit 32, specifically within said plane 28. The second connection element 60′ is connected with the second orientation unit 32′, specifically within said plane 28. A rotational movement of the connection elements 60, 60′ relative to the movers 16, 16′ and/or to the support unit 24 can be generated by means of the orientation units 32, 32′. Due to the coupling of the orientation units 32, 32′ with one another, namely the coupling of the first orientation unit 32 and at least the second orientation unit 32′, the movements of the connection elements 60, 60′, namely of the first connection element 60 and at least the second connection element 60′, are coupled and/or connected with one another and/or depend on one another.

The orientation units 32, 32′ are configured to always align the support unit 24 parallel to the movers 16, 16′. An angle orientation between the support unit 24 and the connection elements 60, 60′ is steplessly adjustable by a movement of at least the orientation units 32, 32′. Furthermore, the orientation units 32, 32′ are configured to always align and hold the main extension plane of the support unit 24 at least substantially parallel to the main extension plane of the movers 16, 16′, specifically advantageously at least during a movement of at least one of the connection elements 60, 60′ and/or of the movers 16, 16′.

FIGS. 2 to 7 show that the orientation units 32, 32′ each comprise at least one bevel gear 36, 36′. Furthermore, the orientation units 32, 32′ each comprise at least one bevel wheel 38, 38′. In the present case, each orientation unit 32, 32′, specifically the first orientation unit 32 and at least the second orientation unit 32′, comprises at least one pair of bevel wheels 38, 38′. In the present case, the bevel gear 36, 36′ is in each case realized as a pair of bevel wheels 38, 38′.

In order to provide a particularly efficient, compact and flexible construction, the bevel wheels 38, 38′ are respectively arranged in a corner region 50, 50′ of the support unit 24. In the present case, the bevel wheels 38, 38′ are arranged in a corner region 50, 50′ of the frame element 66. Due to the angular shape of the support unit 24, in this exemplary implementation the support unit 24 comprises a total of four corner regions 50, 50′, wherein only two of these are provided with a reference numeral and described in more detail. The implementations and descriptions relating to the corner regions 50, 50′ can likewise be transferred to the further corner regions of the support unit 24. In the present case, the first orientation unit 32, specifically at least one first bevel gear 36 comprising in the present case at least one pair of bevel wheels 38, is arranged in a first corner region 50 of the support unit 24. The second orientation unit 32′, specifically at least one second bevel gear 36′ comprising in the present case at least one pair of bevel wheels 38′, is arranged in a second corner region 50′ of the support unit 24 (see FIGS. 2 to 7).

The bevel gears 36, 36′ are connected to one another by a shaft 56. The shaft 56 is part of the product handling device 12. The shaft 56 is also part of the coupling unit 18. The coupling unit 18 may comprise further shafts 56 for connecting orientation units 32, 32′ to one another, wherein preferably the number of shafts 56 is related to a number of orientation units 32, 32′. In this exemplary embodiment the coupling unit 18 comprises respectively one shaft 56 per two orientation units 32, 32′. In this exemplary implementation the coupling unit 18 comprises at least two shafts 56, wherein only one of the shafts 56 is provided with a reference numeral and described in detail. The shaft 56 is configured to connect the first orientation unit 32 with at least the second orientation unit 32′. The shaft 56 extends from the first corner region 50 to the second corner region 50′. In the present case, the frame element 66 accommodates at least the shaft 56. The shaft 56 is arranged within the frame element 66, specifically completely surrounded and/or enclosed and/or covered by the frame element 66. Alternatively, the shaft 56 may also be arranged at least partially outside on the frame element 66, for example fixed and/or held on the frame element 66.

According to FIG. 1, two different positions and/or arrangements of the movers 16, 16′ with respect to the base unit 52 and the support unit 24 are shown. The already mentioned control unit 20 is configured, for a transport of the product 14, in at least one first operation state, to position at least one of the movers 16, 16′ below the support unit 24 in a perpendicular view onto the plane 28. Furthermore, in this exemplary embodiment the control unit 20 is configured, in the first operation state, to position the two movers 16, 16′ beside one another below the support unit 24 in a perpendicular view onto the plane 28. FIGS. 2 to 4 illustrate the first operation state and the associated arrangement and/or positioning of the movers 16, 16′ with respect to the support unit 24.

The first operation state may also be referred to as a transport operation state for a transport at least of the product 14. In the present case, in at least the first operation state, the at least two movers 16, 16′ are situated jointly with respect to the base unit 52, specifically parallel to the aforementioned plane 28 in which the support unit 24 is arranged. In at least the first operation state, the control unit 20 actuates at least the two movers 16, 16′, specifically the first mover 16 and the second mover 16′, in such a way that in a perpendicular view onto the plane 28, the two movers 16, 16′ are arranged and/or positioned below the support unit 24. Viewed in a height direction 62 according to FIGS. 2 and 3, the two movers 16, 16′ are arranged below the support unit 24. In this exemplary implementation and according to the top view in FIG. 4, the movers 16, 16′ are arranged below the support unit 24 with equal percentages. Furthermore, in at least the first operation state, the two movers 16, 16′ are arranged completely below the support unit 24 in a perpendicular view onto the plane 28. Alternatively, the movers 16, 16′ could be arranged at different distances below the support unit 24 (not shown). In at least the first operation state, the at least two movers 16, 16′, specifically the first mover 16 and at least the second mover 16′, are arranged and/or positioned in an almost contact-flush manner, specifically—in the present case—arranged and/or positioned beside one another and spaced apart from one another. For example, at least in the first operation state, a distance between the first mover 16 and the at least second mover 16′ amounts to at most 3 cm.

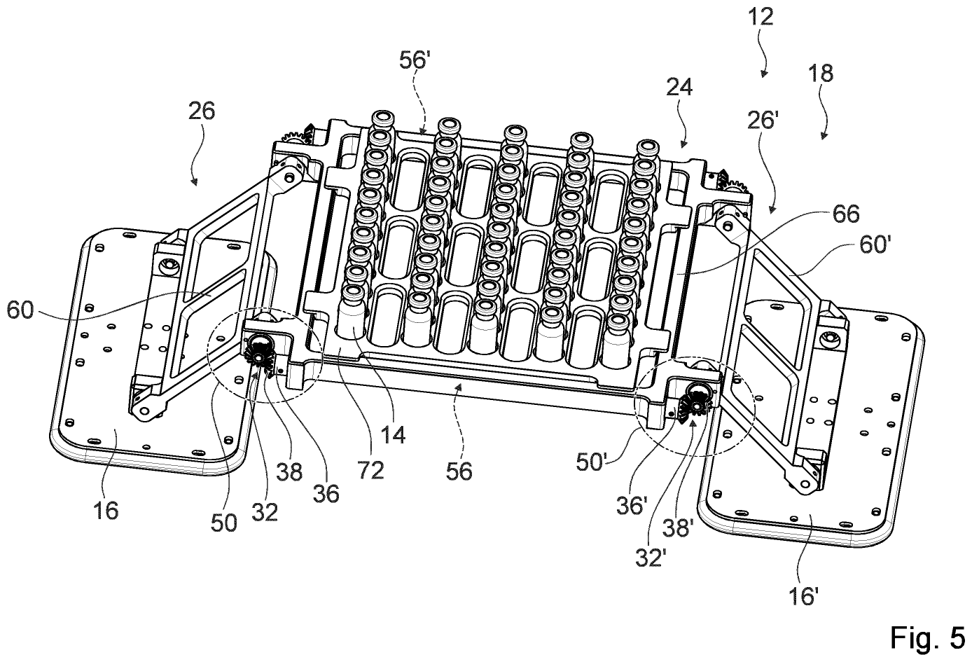

Furthermore, for a further treatment of the product 14, 14′, the control unit 20 is configured, in at least one second operation state, to position at least one of the movers 16, 16′ at least partially beside the support unit 24 in a perpendicular view onto the plane 28. In this exemplary implementation, the control unit 20 is configured, in the second operation state, to position the two movers 16, 16′, specifically the first mover 16 and at least the second mover 16′, at least partially beside the support unit 24 in a perpendicular view onto the plane 28. FIGS. 5 to 7 illustrate the second operation state and the associated arrangement and/or positioning of the movers 16, 16′ with respect to the support unit 24. Furthermore, in FIG. 1 a product processing unit 70 of the production machine 10 is schematically illustrated, which is arranged at least partially in a region within the base unit 52 and by means of which at least the product 14 can be further processed. For example, at least the product 14 can be further packaged, closed, weighed, removed out of/from the support unit 24 and/or re-inserted into/onto the support unit 24 by means of the product processing unit 70.

In at least the second operation state, the movers 16, 16′ could also be arranged at different distances beside/below the support unit 24 (not shown), specifically at least partially beside/below the support unit 24 in a perpendicular view onto the plane 28. In this exemplary implementation and according to the top view in FIG. 7, the movers 16, 16′ are arranged beside the support unit 24 with equal percentages. Furthermore, in at least the second operation state, the two movers 16, 16′ are arranged completely beside the support unit 24 in a perpendicular view onto the plane 28. This allows ensuring and/or providing particularly favorable accessibility of the products 14 for the further processing of the products 14. This in turn also allows increasing flexibility when handling products 14.

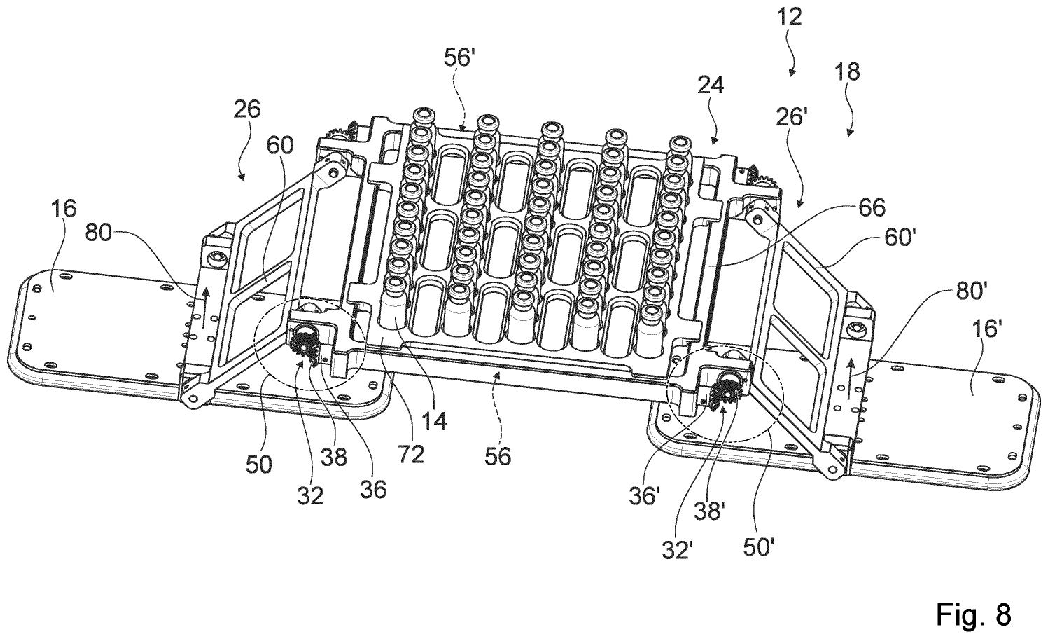

In order to improve efficiency and flexibility when handling products 14, at least one of the two movers 16, 16′ is supported rotatably around a rotation axis 80, 80′ relative to the coupling unit 18. FIG. 8 shows an illustration of the product handling device 12 with the at least two movers 16, 16′ and the coupling unit 18 in the second operation state, wherein in the present case the two movers 16, 16′ are respectively rotated relative to the coupling unit 18 around the rotation axis 80, 80′. The first mover 16 comprises a first rotary bearing with a first rotation axis 80 around which the first mover 16 is supported rotatably relative to the coupling unit 18. Furthermore, the second mover 16′ comprises a second rotary bearing with a second rotation axis 80′ around which the second mover 16′ is supported rotatably relative to the coupling unit 18. In this exemplary implementation, the two movers 16, 16′ are arranged so as to be rotated by 90°, specifically compared to an initial position of the movers 16, 16′ according to FIG. 5. Alternatively, it is also possible that only one of the two movers 16, 16′, specifically the first mover 16 or the second mover 16′, is rotated. At least one of the two movers 16, 16′ is rotatable around the respective rotation axis 80, 80′ by any desired angle between 0° and 360°. Alternatively or additionally, at least one of the two movers 16, 16′, specifically the first mover 16 and/or the second mover 16′, may be configured to perform a tilting and/or pivoting movement around the respective rotation axis 80, 80′. In the present case, the control unit 20 is configured to actuate at least one of the two movers 16, 16′ in such a way that it performs the rotating, tilting and/or pivoting movement around the respective rotation axis 80, 80′ relative to the coupling unit 18. The control unit 20 is configured to actuate the drive unit 68 for moving, specifically rotating, tilting and/or pivoting, at least one of the two movers 16, 16′, specifically the first mover 16 and/or at least the second mover 16′, with respect to the base unit 52.

1. A product handling device (12) for the handling of products (14), comprising:
at least two movers (16, 16′);
and a coupling unit (18) which mechanically couples the movers (16, 16′) with one another;
wherein the coupling unit (18) comprises a support unit (24) for at least one product (14) and at least two connection units (26, 26′), which respectively connect the support unit (24) with at least one of the movers (16, 16′), wherein the connection units (26, 26′) and the support unit (24) are connected to one another within a plane (28) in which the support unit (24) is arranged, wherein the connection units (26, 26′) each comprise at least one orientation unit (32, 32′), the orientation units being coupled with one another, and wherein the orientation units (32, 32′) each comprise at least one bevel gear (36, 36′)

2. The product handling device (12) according to claim 1, wherein the connection units (26, 26′) are connected to the support unit (24) in an outer peripheral region of the support unit (24).

3. (canceled)

4. The product handling device (12) according to claim 1, wherein the orientation units (32, 32′) are connected to one another within the plane (28) in which the support unit (24) is arranged.

5. The product handling device (12) according to claim 1, wherein the orientation units (32, 32′) are configured to always align the support unit (24) parallel to the movers (16, 16′).

6. (canceled)

7. The product handling device (12) according to claim 1, wherein the orientation units (32, 32′) each comprise at least one bevel wheel (38, 38′).

8. The product handling device (12) according to claim 7, wherein the bevel wheels (38, 38′) are respectively arranged in a corner region (50, 50′) of the support unit (24).

9. The product handling device (12) according to claim 1, wherein the bevel gears (36, 36′) are connected to one another by a shaft (56).

10. The product handling device (12) according claim 1, further comprising a control unit (20) which is configured, for a transport of the product (14), in at least one first operation state, to position at least one of the movers (16, 16′) below the support unit (24) in a perpendicular view onto the plane (28).

11. The product handling device (12) according to claim 10, wherein the control unit (20) is configured, in the first operation state, to position the at least two movers (16, 16′) beside one another below the support unit (24) in a perpendicular view onto the plane (28).

12. The product handling device (12) according to claim 1, further comprising a control unit (20) which is configured, for a transport of the product (14), in at least one first operation state, to position at least one of the movers (16, 16′) below the support unit (24) in a perpendicular view onto the plane (28), wherein for a further treatment of the product (14, 14′), the control unit (20) is configured, in at least one second operation state, to position at least one of the movers (16, 16′) at least partially beside the support unit (24) in a perpendicular view onto the plane (28).

13. The product handling device (12) according to claim 12, wherein the control unit (20) is configured, in the second operation state, to position the at least two movers (16, 16′) at least partially beside the support unit (24) in a perpendicular view onto the plane (28).

14. The product handling device (12) according to claim 1, wherein at least one of the at least two movers (16, 16′) is supported rotatably relative to the coupling unit (18) around a rotation axis (80, 80′).

15. A production machine (10) with a product handling device (12) according to claim 1.
